(19) United States
(12) Patent Application Publication
(10) Pub. No.: US 2026/0098471 A1
(43) Pub. Date: Apr. 9, 2026

(54) Wireless load cell

(71) Applicant: Dechuan ZHOU, Shanghai (CN)

(72) Inventor: Dechuan ZHOU, Shanghai (CN)

(21) Appl. No.: 18/909,967

(22) Filed: Oct. 9, 2024

(51) Int. Cl. E21B 47/13; E21B 47/009; H02J 7/34; H02J 7/35

(52) U.S. Cl. CPC E21B 47/13; H02J 7/342; H02J 7/35; E21B 47/009; H02J 2101/22; H02J 2207/10

(57) ABSTRACT

A wireless load cell is provided. The wireless load cell includes a wireless load cell measuring unit and a wireless signal receiving unit; the wireless load cell measuring unit includes: a load cell; a controllable switch; a multi-power supply module including a solar panel, a first storage battery, and a standby battery, where the solar panel includes a first terminal connected to a second terminal of the controllable switch, and a second terminal connected to the load cell; the first storage battery includes a first terminal connected to a third terminal of the controllable switch, and a second terminal connected to the load cell; and the standby battery includes a first terminal connected to a fourth terminal of the controllable switch, and a second terminal connected to the load cell; and an automatic switching control circuit is configured to switch the controllable switch.

### TECHNICAL FIELD

The present disclosure relates to the technical field of industrial equipment, and in particular to a wireless load cell.

### BACKGROUND

An oil pumping unit is a type of machinery used for extracting oil, commonly referred to as a “nodding donkey.” It uses pressure to bring oil to the surface. Oil pumping units are often employed in extremely harsh environmental conditions for oil extraction, such as in deserts, cold regions, high-altitude areas, or offshore locations, where human access is difficult. The equipment typically operates in an unattended state year-round.

A load cell is installed on the polished rod of the oil pumping unit. The load cell measures and outputs load signals to the oil pumping unit's electronic control system, forming a pump performance curve alongside other signals for the reciprocating operation of the oil pumping unit. This enables automatic speed regulation, intermittent operation, and provides shutdown protection in special circumstances.

Traditional wired loads can provide continuous and stable signal output; however, cables often become tangled or damaged during the operation of oil pumping unit, leading to equipment shutdown due to signal loss. The initial installation of cables and subsequent maintenance and replacement of cables incur significant unnecessary labor costs. Wireless load cells have gradually garnered attention in the industry and are becoming the development direction for new types of load cells. Existing mature wireless load cells achieve wireless power supply through a solar panel and a rechargeable battery. However, during winter solar panel may become covered with snow due to extreme cold weather, preventing it from functioning properly. This condition can persist for months, with ice and snow difficult to melt, leading to the rechargeable battery also losing its power supply. As a result, the load cell fails to operate due to a lack of power, which impacts production capacity. Additionally, the remoteness of the oil pumping unit's location and its unattended nature can make it challenging to address power supply issues in a timely manner (for example, removing accumulated snow from the solar panel and ensuring that the solar panel is exposed to direct sunlight for several days to fully charge the rechargeable battery).

### SUMMARY

To address the aforementioned technical issues, the present disclosure provides a wireless load cell.

An embodiment of the present disclosure offers a wireless load cell that includes: a wireless load cell measuring unit and a wireless signal receiving unit. The wireless load cell measuring unit includes: a load cell; a controllable switch, with the first terminal connected to the load cell; a multi-power supply module, which includes: a solar panel, a first storage battery, and a standby battery. The first terminal of the solar panel is connected to the second terminal of the controllable switch through a voltage regulation circuit; the second terminal of the solar panel is connected to the load cell; the first terminal of the first storage battery is connected to the third terminal of the controllable switch; the second terminal of the first storage battery is connected to the load cell; the first terminal of the standby battery is connected to the fourth terminal of the controllable switch; the second terminal of the standby battery is connected to the load cell; the third terminal of the solar panel is connected to the first storage battery through a first charging circuit; and an automatic switching control circuit connected to the controllable switch, which is used to control the controllable switch based on the status of the multi-power supply module obtained. The wireless signal receiving unit is used to receive the load signals transmitted by the wireless load cell measuring unit and is equipped with indicator lights to display the charge status of the first storage battery and the standby battery.

Optionally, the automatic switching control circuit is specifically configured to control the controllable switch to switch to the solar panel for powering the load cell when it detects that the charge of the first storage battery is greater than or equal to its rated capacity.

Optionally, the automatic switching control circuit is specifically designed to control the controllable switch to power the load cell using the first storage battery when it detects that the charge of the first storage battery is greater than or equal to one-fifth of its rated capacity but less than its rated capacity.

Optionally, the automatic switching control circuit can be configured to control the controllable switch to switch to the standby battery for powering the load cell when it detects that the charge of the first storage battery is less than one-fifth of its rated capacity.

Optionally, the standby battery is a dry battery or a replaceable storage battery.

Optionally, the standby battery is a second storage battery; and the fourth terminal of the solar panel is connected to the second storage battery through a second charging circuit.

Optionally, the automatic switching control circuit is further specifically designed to control the controllable switch to power the load cell using the second storage battery based on a preset cycle, switching from the first storage battery to the second storage battery. The automatic switching control circuit can also control the controllable switch to switch from the second storage battery back to the first storage battery for powering the load cell according to the preset cycle.

Optionally, the wireless load cell further includes a data processor and an antenna transmitting module unit; the data processor is connected to the antenna transmitting module unit; the antenna transmitting module unit is connected to the load cell. The data processor is specifically configured to convert the power supply strategy of the antenna transmitting module unit from a first power supply strategy to a second power supply strategy when it detects that power supply of the standby battery meets preset conditions. In this context, the transmission frequency of the antenna transmitting module unit in the first power supply strategy is greater than the transmission frequency of the antenna transmitting module unit in the second power supply strategy.

Optionally, the preset conditions include at least one of these conditions: the charge of the standby battery is less than 80% of its rated capacity, or the service time of the standby battery is greater than a preset duration.

Optionally, the second power supply strategy includes a plurality of different transmission frequencies; the data processor is further configured to lower the transmission frequency of the antenna transmitting module unit to a transmission frequency that matches the charge level of the standby battery in the second power supply strategy. In this context, the lower the charge level of the standby battery, the lower the matching transmission frequency.

Optionally, the data processor is further configured to convert the power supply strategy of the antenna transmitting module unit from the second power supply strategy to the third power supply strategy when it detects that the transmission frequency of the antenna transmitting module unit is below one-half to one-third of the initial transmission frequency. In this context, the transmission power of the antenna transmitting module unit in the second power supply strategy is higher than that in the third power supply strategy.

Optionally, the wireless load cell includes a housing; the controllable switch, the first storage battery, the standby battery, and the automatic switching control circuit are provided in the housing; the solar panel is provided on a surface of the housing; and the load cell is provided on an outer side of the housing and embedded with the housing.

Optionally, other sensing detection chips including an acceleration sensing chip may further be embedded inside the housing of the wireless cell, so as to detect an operating position of an oil pumping unit.

Optionally, a slotted channel is further provided inside of the housing; an opening-closing door is provided outside the slotted channel; and the standby battery is fixed inside of the slotted channel.

The present disclosure has the following beneficial effects: The wireless load cell provided by the present disclosure includes the load cell, the controllable switch, the automatic switching control circuit, and the multi-power supply module. The multi-power supply module includes the solar panel, the first storage battery, and the standby battery. The automatic switching control circuit is configured to switch the controllable switch based on the status acquired from the multi-power supply module. That is, based on the status acquired from the multi-power supply module, the automatic switching control circuit may be configured to control the solar panel, the first storage battery or the standby battery to supply power. The present disclosure optimizes a power supply method of the wireless load cell. For example, in case of direct sunlight, the first storage battery comes into a fully charged state. In a fully-charged state of the first storage battery, the solar panel is used directly to supply the power. The present disclosure effectively utilizes solar energy and prevent waste of the energy converted from sunlight. Meanwhile, when the solar panel covered by snow in extreme cold weather conditions, rendering it non-functional and leading to the loss of energy supply of the first storage battery, the standby battery can continue to maintain the power supply. Therefore, the wireless load cell can be effectively applied in remote regions and extreme weather environments.

### BRIEF DESCRIPTION OF THE DRAWINGS

FIG. 1 is a module block diagram of a wireless load cell of a first type according to the present disclosure;

FIG. 2 is a module block diagram of an automatic switching control circuit according to the present disclosure;

FIG. 3 is a module block diagram of a wireless load cell of a second type according to the present disclosure;

FIG. 4 is a schematic flowchart of a method for switching a power supply strategy according to the present disclosure;

FIG. 5 is a module schematic diagram of a voltage regulation circuit according to the present disclosure; and

FIG. 6 is a structural schematic diagram of a wireless load cell according to the present disclosure.

In the figures: 100—wireless load cell, 10—load cell, 20—controllable switch, 30—automatic switching control circuit, 40—multi-power supply module, 401—solar panel, 402—first storage battery, 403—standby battery, 50—housing, 501—opening-closing door, and 60—antenna.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All the other embodiments derived by those of ordinary skill in the art based on the embodiments of the present disclosure without creative efforts shall fall within the protection scope of the present disclosure.

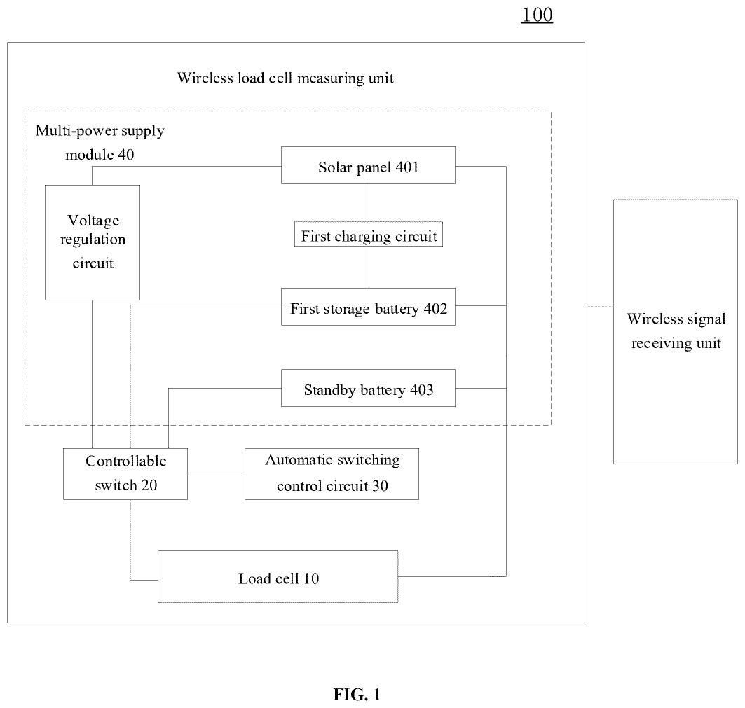

Referring to FIG. 1, an embodiment of the present disclosure provides wireless load cell 100. The wireless load cell includes a wireless load cell measuring unit and a wireless signal receiving unit. The wireless load cell measuring unit includes load cell 10, controllable switch 20, automatic switching control circuit 30, and multi-power supply module 40.

The controllable switch 20 includes a first terminal connected to the load cell 10.

The multi-power supply module 40 specifically includes solar panel 401, first storage battery 402, and standby battery 403.

The solar panel 401 includes a first terminal connected to a second terminal of the controllable switch 20 through a voltage regulation circuit, and a second terminal connected to the load cell 10. The solar panel 401 may be configured to supply power to the load cell 10. The voltage regulation circuit is primarily used for oscillation filtering, enabling the solar panel 401 to provide stable power to the load cell 10.

The first storage battery 402 includes a first terminal connected to a third terminal of the controllable switch 20, and a second terminal connected to the load cell 10.

The standby battery 403 includes a first terminal connected to a fourth terminal of the controllable switch 20, and a second terminal connected to the load cell 10.

A third terminal of the solar panel 401 is further connected to the first storage battery 402 through a first charging circuit. The solar panel 401 is configured to charge the first storage battery 402.

It is to be noted that the first storage battery 402 and the standby battery 403 are in parallel configuration, allowing both to supply power.

The automatic switching control circuit 30 is connected to the controllable switch 20. The automatic switching control circuit 30 is configured to switch the controllable switch based on the status of the multi-power supply module acquired.

The wireless signal receiving unit is configured to receive a load signal transmitted from the wireless load cell measuring unit and is equipped with indicator lights to display the power status of the first storage battery 402 and the standby battery 403.

The wireless load cell 100 provided by the present disclosure includes the load cell 10, the controllable switch 20, the automatic switching control circuit 30, and the multi-power supply module 40. The multi-power supply module 40 specifically includes the solar panel 401, the first storage battery 402, and the standby battery 403. The automatic switching control circuit 30 is configured to switch the controllable switch 20 based on the status of the multi-power supply module 40 acquired. That is, the automatic switching control circuit 30 can manage power supply to the load cell 10 from the solar panel 401, the first storage battery 402 or the standby battery 403 based on the multi-power supply module's status. The present disclosure optimizes a power supply method of the load cell 10. For example, when direct sunlight is present, the first storage battery 402 may reach to a fully charged state, allowing the solar panel 401 to directly supply power. The present disclosure effectively utilizes solar energy and prevent waste of energy converted from direct sunlight. Meanwhile, when the solar panel covered by snow in extreme cold weather conditions, rendering it non-functional and leading to the loss of energy supply of the first storage battery, the standby battery can continue to maintain the power supply. Therefore, the wireless load cell 100 can be effectively applied in remote regions and extreme weather environments.

In an embodiment, the automatic switching control circuit 30 is specifically configured to switch, when detecting that the charge of the first storage battery 402 is greater than or equal to the rated charge of the first storage battery, the controllable switch 20 to the solar panel 401 to supply power to the load cell 10; switch, when detecting that the charge of the first storage battery 402 is greater than or equal to ⅕ of a capacity of the first storage battery but less than the rated charge of the first storage battery, the controllable switch 20 to the first storage battery 402 to supply power to the load cell 10; and switch, when detecting that the charge of the first storage battery 402 is less than ⅕ of the capacity of the first storage battery, the controllable switch 20 to the standby battery 403 to supply power to the load cell 10.

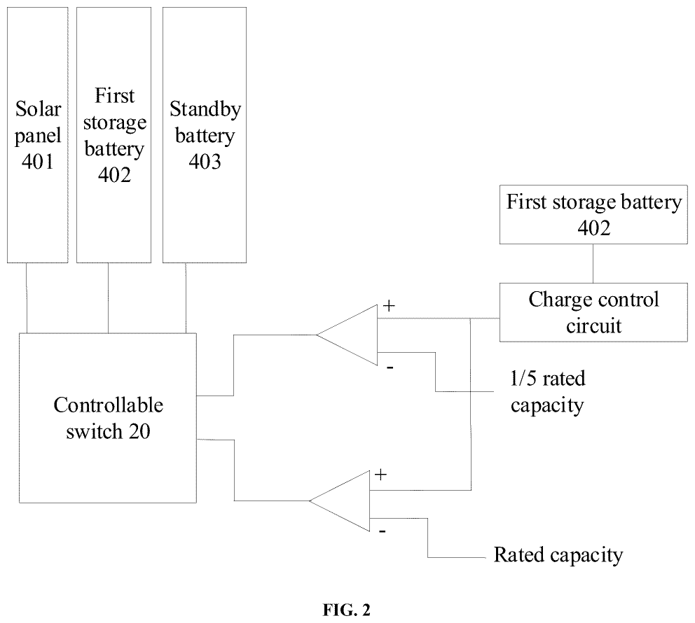

Specifically, referring to FIG. 2, the automatic switching control circuit 30 may be realized through a comparator and a charge control circuit. The charge control circuit is configured to detect the charge of the first storage battery 402. Specifically, when 11 is output by the comparator, the charge of the first storage battery 402 is greater than or equal to the rated charge of the first storage battery, the first storage battery 402 is fully charged, and the solar panel 401 is used directly to supply the power. When 10 is output by the comparator, the charge of the first storage battery 402 falls between a minimum charge and a fully-charged electric quantity, and the first storage battery 402 is used continuously to supply the power. When 00 is output by the comparator, the charge of the first storage battery 402 is less than the minimum charge, and the standby battery 403 is used to supply the power.

To sum up, in the embodiment of the present disclosure, when the first storage battery 402 is fully charged by the solar panel 401, the solar panel 401 is directly used to supply the power to the load cell 10. Therefore, through direct power supply of the solar panel 401, the cycle life of the battery and the system endurance are greatly improved. It is to be noted that the solar battery is usually provided with a relatively high power. In case of the direct sunlight, the storage battery comes into the fully charged state. If the storage battery is used at this time, electrical energy converted by the solar battery will be wasted, which is disadvantageous to cope with sudden weather changes and other extreme environments.

In an embodiment, the automatic switching control circuit 30 is further configured to switch, when detecting that the charge of the first storage battery 402 is less than a first preset charge, the controllable switch to the standby battery 403 to supply power to the load cell 10. In an embodiment, the standby battery 403 is a dry battery.

That is, in the embodiment, the solar panel 401, the first storage battery 402, and the dry battery serve as a power source to provide electrical energy for the load cell 10.

It is to be noted that the storage battery at a temperature less than about minus 20° C. has a lower output voltage and is problematic to supply the power. However, the dry battery can work at about minus 50° C., and can ensure normal power supply to the load cell 10 in extreme cold weather.

In an embodiment, the standby battery may be a replaceable storage battery, and may specifically be a second storage battery.

That is, in the embodiment, the solar panel 401 and the two storage batteries serve as a power source to provide electrical energy for the load cell 10.

Optionally, a fourth terminal of the solar panel 401 may be connected to the second storage battery through a second charging circuit. That is, the connection relationship of the second storage battery may refer to the connection relationship of the first storage battery. Same contents on the first storage battery and the second storage battery may refer to each other, and will not be repeated herein.

The first storage battery 402 may serve as the active battery, while the second storage battery may serve as the standby battery.

Optionally, an active-standby switching strategy is provided for the first storage battery 402 and the second storage battery. Specifically, the automatic switching control circuit 30 is further specifically configured to switch, according to a preset cycle, the controllable switch 20 from the first storage battery 402 to the second storage battery to supply power to the load cell 10, or, switch, according to the preset cycle, the controllable switch 20 from the second storage battery to the first storage battery 402 to supply power to the load cell 10.

The preset cycle may be, but is not limited to, 15 days, 16 days, 20 days, etc. Alternatively, the preset cycle may be any number of days within 15-20 days, and is not limited in the present disclosure.

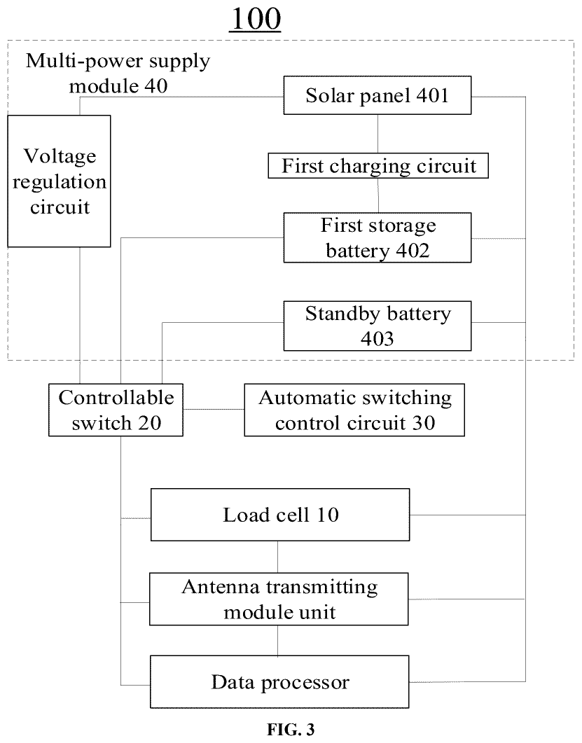

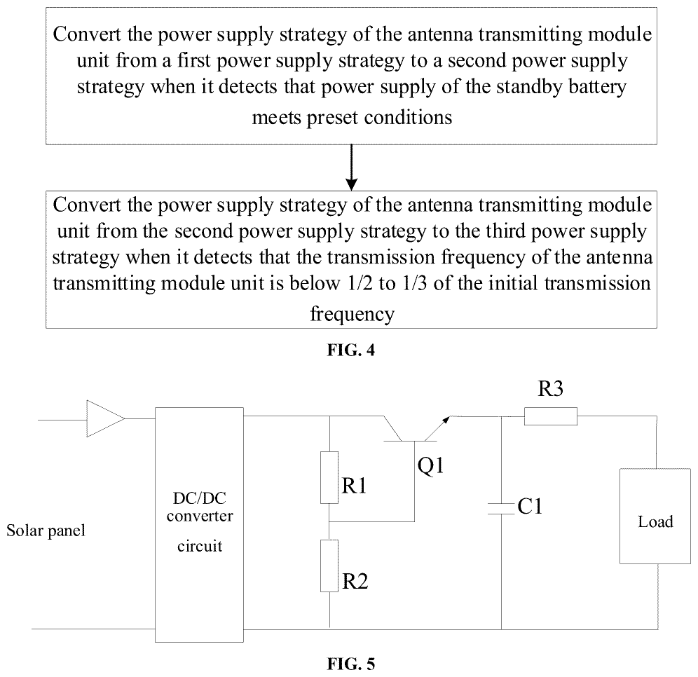

An embodiment of the present disclosure further provides a power control strategy. Specifically, referring to FIG. 3 and FIG. 4, the wireless load cell 100 further includes a data processor and an antenna transmitting module unit. The data processor is connected to the antenna transmitting module unit. The antenna transmitting module unit is connected to the load cell 10. The data processor is specifically configured to convert, when detecting that power supply of the standby battery 403 reaches preset conditions, a power supply strategy of the antenna transmitting module unit from a first power supply strategy to a second power supply strategy. A transmission frequency of the antenna transmitting module unit in the first power supply strategy is greater than a transmission frequency of the antenna transmitting module unit in the second power supply strategy.

The preset conditions include at least one of a condition where a charge of the standby battery 403 is less than 80% of a rated capacity of the standby battery 403, and a condition where service time of the standby battery 403 is greater than a preset duration.

It is to be noted that the first power supply strategy may be normal continuous high-power supply, such that the antenna of the load cell 10 can realize continuous or relatively high-frequency signal transmission and reception, thereby achieving a longer transmission distance and higher stability of the wireless signal. The second power supply strategy is intended to lower the transmission frequency, without changing the transmission power. It is to be noted that the transmission frequency of the antenna is different from the working frequency of the antenna. Herein, the transmission frequency does not mean a signal transfer frequency, but a signal transmission frequency. For example, the first power supply strategy is to acquire and transmit data every 5 min normally, but the second power supply strategy is to acquire and transmit the data every 8 min now. Therefore, this method can effectively reduce overall power consumption of the wireless load cell 100.

The preset duration may be service time of the standby battery 403, and is 5 days. It is to be noted that the second power supply strategy is used in case of extreme weathers, for example, the solar panel is covered by ice and snow, there is no sunlight, and solar energy cannot be supplied to the storage battery.

Optionally, the second power supply strategy includes a plurality of different transmission frequencies. The data processor is further configured to lower a transmission frequency of the antenna transmitting module unit to a transmission frequency matching with the charge of the standby battery 403 in the second power supply strategy. A lower charge of the standby battery 403 indicates a lower matching transmission frequency.

In other words, in the second power supply strategy, the transmission frequency of the antenna transmitting module unit is lowered stepwise, specifically depending on the detected charge of the standby battery 403.

Correspondingly, the data processor is further configured to convert, when detecting that the transmission frequency of the antenna transmitting module unit is less than ½-⅓ of an initial transmission frequency, the power supply strategy of the antenna transmitting module unit from the second power supply strategy to a third power supply strategy. A transmission power of the antenna transmitting module unit in the second power supply strategy is greater than a transmission power of the antenna transmitting module unit in the third power supply strategy.

Exemplarily, when the transmission frequency in data acquisition is lowered to be less than ½-⅓ of the transmission power of the antenna of the load cell 10 in the first power supply strategy, the transmission power is reduced to prolong a supply duration of the battery. That is, while the transmission frequency is lowered, the power of the transmitted signal is reduced to supply the power for longer time.

It is to be noted that the power control strategy is intended to keep the overall energy supply until normal routine maintenance time, and further prevent emergency maintenance in the fault (insufficient power supply). The emergency maintenance involves numerous human and material resource (for example, during the emergency maintenance, the road is blocked by heavy snow and becomes unavailable, etc.) Specifically, due to the maintenance distance for hundreds of kilometers, and the harsh environment, the oil exploitation environments are facing seasonal and long-time shortage of the electrical energy and the like (overwintering capacities of similar devices). The following quantitative description is made on a cycle of a specific scene (for example, the rainy and snowy weathers last for months, the solar panel is covered by heavy snow, and the solar energy provides subsaturated power supply (the conversion efficiency of the electrical energy is insufficient due to a surface lossless condition) in the power control strategy. The cycle may be a routine maintenance cycle (the routine maintenance is different from the emergency maintenance. When the solar panel is stained with reduced conversion efficiency of the electrical energy, the equipment system should work until the routine maintenance cycle, so as to prevent the emergency maintenance). Therefore, through the power control strategy, the oil exploitation environments can be accommodated effectively.

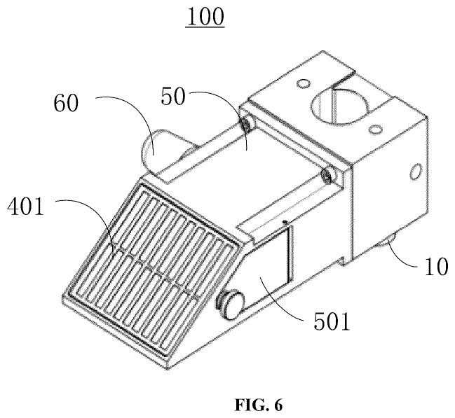

The following description is made on the voltage regulation circuit in an embodiment of the present disclosure. Referring to FIG. 5, the voltage regulation circuit includes a direct current (DC)/DC converter circuit, resistor R1, resistor R2, resistor R3, triode Q1, and supercapacitor C1.

Referring to FIG. 6, the wireless load cell 100 further includes housing 50.

The controllable switch 20, the first storage battery 402, the standby battery 403, and the automatic switching control circuit 30 are provided in the housing 50. The solar panel 401 is provided on a surface of the housing 50. The load cell 10 is provided on an outer side of the housing 50 and embedded with the housing 50.

The antenna 60 in the antenna transmitting module unit is also provided at a side of the housing 50.

Other sensing detection chips including an acceleration sensing chip may further be embedded inside the housing 50 of the wireless cell 100, so as to detect an operating position of an oil pumping unit.

In the embodiment of the present disclosure, a slotted channel is further provided inside the housing 50. Opening-closing door 501 is provided outside the slotted channel. The standby battery 403 is fixed inside of the slotted channel. That is, through the opening-closing door 501, the standby battery 403 can be replaced conveniently.

In addition, in the embodiment of the present disclosure, an angle of the solar panel 401 may also be adjusted, so as to accommodate different light environments.

In the description of the present disclosure, it should be understood that terms such as “upper”, “lower”, “front”, “rear”, “left”, “right”, “vertical”, “horizontal”, “central”, “top”, “bottom”, “top portion”, “bottom portion”, “inside”, “outside”, “inner side” and “outer side” are intended to indicate the orientation or position relationships based on the drawings. They are merely intended to facilitate and simplify the description of the present disclosure, rather than to indicate or imply that the mentioned device or components must have the specific orientation or must be constructed and operated in the specific orientation. Therefore, these terms should not be understood as a limitation to the present disclosure. The “inside” refers to an interior or enclosed region or space, and the “outside” refers to a region surrounding a particular component or particular region.

In the description of the embodiments of the present disclosure, the terms such as “first”, “second”, “third” and “fourth” are used only for the purpose of description, rather than to imply relative importance or implicitly indicate a quantity of the technical features. Therefore, the features defined by the terms “first”, “second”, “third” and “fourth” may explicitly or implicitly include one or more of the features. In the description of the present disclosure, unless otherwise specified, “a plurality of” means two or more.

It should be understood that, in the description of the embodiments of the present disclosure, unless otherwise specified, the phrases “provided with”, “connected”, “connection” and “assembled” should be comprehended in a broad sense. For example, “connection” may be a fixed connection, a detachable connection or an integrated connection, may be a direct connection or an indirect connection via a medium, or may be intercommunication between two components. Those of ordinary skill in the art may understand specific meanings of the foregoing terms in the present disclosure based on a specific situation.

In the description of the embodiments of the present disclosure, the specific features, structures, materials or characteristics may be combined in any suitable manner in any one or more embodiments or examples.

It should be understood that, in the description of the embodiments of the present disclosure, “-” and “to” are used to represent a range between two numerical values, and the range includes the endpoints. For example: “A-B” means a range greater than or equal to A and less than or equal to B, and “A to B” means the range greater than or equal to A and less than or equal to B.

It should be understood that, in the description of the embodiments of the present disclosure, the term “and/or” merely describes associations between associated objects, and it indicates three types of relationships. For example, A and/or B may indicate that A alone, A and B, or B alone. In addition, the character “/” in this specification generally indicates that the associated objects are in an “or” relationship.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

1. A wireless load cell, comprising a wireless load cell measuring unit and a wireless signal receiving unit, wherein the wireless load cell measuring unit comprises:
a load cell;
a controllable switch, wherein the controllable switch comprises a first terminal connected to the load cell;
a multi-power supply module comprising a solar panel, a first storage battery, and a standby battery, wherein the solar panel comprises a first terminal connected to a second terminal of the controllable switch through a voltage regulation circuit, and a second terminal connected to the load cell; the first storage battery comprises a first terminal connected to a third terminal of the controllable switch, and a second terminal connected to the load cell; the standby battery comprises a first terminal connected to a fourth terminal of the controllable switch, and a second terminal connected to the load cell; and a third terminal of the solar panel is connected to the first storage battery through a first charging circuit; and
an automatic switching control circuit connected to the controllable switch, wherein the automatic switching control circuit is configured to switch the controllable switch based on status of the multi-power supply module acquired; and
the wireless signal receiving unit is configured to receive a load signal transmitted from the wireless load cell measuring unit and equipped with indicator lights to display power status of the first storage battery and the standby battery.

2. The wireless load cell according to claim 1, wherein the automatic switching control circuit is configured to switch, when detecting that a charge of the first storage battery is greater than or equal to a rated charge of the first storage battery, the controllable switch to the solar panel to supply power to the load cell.

3. The wireless load cell according to claim 1, wherein the automatic switching control circuit is configured to switch, when detecting that a charge of the first storage battery is greater than or equal to ⅕ of a capacity of the first storage battery but less than a rated charge of the first storage battery, the controllable switch to the first storage battery to supply power to the load cell.

4. The wireless load cell according to claim 1, wherein the automatic switching control circuit is configured to switch, when detecting that a charge of the first storage battery is less than ⅕ of a capacity of the first storage battery, the controllable switch to the standby battery to supply power to the load cell.

5. The wireless load cell according to claim 1, wherein the standby battery is a dry battery or a replaceable storage battery.

6. The wireless load cell according to claim 1, wherein the standby battery is a second storage battery; and a fourth terminal of the solar panel is connected to the second storage battery through a second charging circuit.

7. The wireless load cell according to claim 6, wherein the automatic switching control circuit is further configured to switch, according to a preset cycle, the controllable switch from the first storage battery to the second storage battery to supply power to the load cell; and the automatic switching control circuit is further configured to switch, according to the preset cycle, the controllable switch from the second storage battery to the first storage battery to supply power to the load cell.

8. The wireless load cell according to claim 1, wherein the wireless load cell further comprises a data processor and an antenna transmitting module unit;
the data processor is connected to the antenna transmitting module unit;
the antenna transmitting module unit is connected to the load cell; and
the data processor is configured to convert, when detecting that power supply of the standby battery reaches a preset condition, a power supply strategy of the antenna transmitting module unit from a first power supply strategy to a second power supply strategy, wherein a transmission frequency of the antenna transmitting module unit in the first power supply strategy is greater than a transmission frequency of the antenna transmitting module unit in the second power supply strategy.

9. The wireless load cell according to claim 8, wherein the preset condition comprises at least one of a condition where a charge of the standby battery is less than 80% of a rated capacity of the standby battery, and a condition where service time of the standby battery is greater than a preset duration.

10. The wireless load cell according to claim 9, wherein the second power supply strategy comprises a plurality of different transmission frequencies; the data processor is further configured to lower a transmission frequency of the antenna transmitting module unit to a transmission frequency matching with the charge of the standby battery in the second power supply strategy; and a lower charge of the standby battery indicates a lower matching transmission frequency.

11. The wireless load cell according to claim 10, wherein the data processor is further configured to convert, when detecting that the transmission frequency of the antenna transmitting module unit is less than ½-⅓ of an initial transmission frequency, the power supply strategy of the antenna transmitting module unit from the second power supply strategy to a third power supply strategy, wherein a transmission power of the antenna transmitting module unit in the second power supply strategy is greater than a transmission power of the antenna transmitting module unit in the third power supply strategy.

12. The wireless load cell according to claim 1, wherein the wireless load cell comprises a housing; and
the controllable switch, the first storage battery, the standby battery, and the automatic switching control circuit are provided in the housing; the solar panel is provided on a surface of the housing; and the load cell is provided on an outer side of the housing and embedded with the housing.

13. The wireless load cell according to claim 12, wherein other sensing detection chips comprising an acceleration sensing chip are further embedded inside the housing of the wireless load cell to detect an operating position of an oil pumping unit.

14. The wireless load cell according to claim 12, wherein a slotted channel is further provided inside of the housing; an opening-closing door is provided outside the slotted channel; and the standby battery is fixed inside of the slotted channel.
